(19) United States
(12) Patent Application Publication
(10) Pub. No.: US 2011/0069217 A1
(43) Pub. Date: Mar. 24, 2011

(54) IMAGE PICKUP APPARATUS HAVING AUTOFOCUS FUNCTION, AND LENS UNIT

(75) Inventors: Shinji IMADA, Utsunomiya-shi (JP); Goro NOTO, Tokyo (JP)

(73) Assignee: CANON KABUSHIKI KAISHA, Tokyo (JP)

(21) Appl. No.: 12/882,736

(22) Filed: Sep. 15, 2010

(30) Foreign Application Priority Data
Sep. 18, 2009 (JP) 2009-216320

(51) Int. Cl. H04N 5/232; G02B 7/09

(52) U.S. Cl. 348/345; 359/698; 348/E05.045

(57) ABSTRACT

An image pickup apparatus includes a magnification information acquisition unit configured to acquire information on an image pickup magnification of an image pickup optical system, and a controller configured to select a first focus control that stops a focus control after an on-focus state of the image pickup optical system is obtained by the focus control, and a second focus control that continues the focus control even after the on-focus state of the image pickup optical system is obtained by the focus control. The controller sets the first focus control mode when the information on the image pickup magnification is information corresponding to image pickup magnification smaller than a predetermined value, and the controller sets the second focus control mode when the information on the image pickup magnification is information corresponding to image pickup magnification equal to or larger than the predetermined value.

### BACKGROUND OF THE INVENTION

1. Field of the Invention

The present invention relates to an image pickup apparatus having an autofocus (“AF”) function, such as a digital still camera, and a lens unit to be detachably attached to the image pickup apparatus.

2. Description of the Related Art

This type of image pickup apparatus includes, as an AF mode that can be selected by a user, a one-shot mode that stops the AF after the on-focus state is obtained by the AF, and a continuous mode that continues the AF even after the on-focus state is obtained by the AF. The one-shot mode is usually suitable for photography of a still object, and the continuous mode is suitable for photography of a motion object (moving body).

The one-shot mode is also usually used for macro photography at a position close to a still object. However, a slight hand shake in a focusing direction (image pickup optical axis direction) causes defocus in the macro photography.

Japanese Patent Laid-Open No. (“JP”) 2004-085843 discloses an image pickup apparatus configured to automatically set the continuous mode by detecting a focus state of an image pickup optical system even after the on-focus is obtained in the one-shot mode, and by regarding an object as a moving body when defocus occurs. The defocus caused by the hand shake in the focusing direction can be reduced by applying this AF mode switching function to the macro photography, and by detecting defocus after the on-focus state is obtained in the one-shot mode.

The image pickup apparatus disclosed in JP 2004-085843 switches to the continuous mode after detecting the defocuses a plurality of times in order to prevent an erroneous detection of a moving body. It therefore takes comparatively a long time to switch the one-shot mode to the continuous mode in the macro photography, and the defocus cannot be reduced during that time period.

On the other hand, in order to quickly find a moving body, JP 2001-021794 discloses an image pickup apparatus configured to regard that an object as a moving body when a defocus amount is monotonously changing.

Since the defocus in the macro photography is caused by the user's hand shake in the focusing direction, the defocus velocity and defocus direction frequently vary and the defocus amount seldom monotonously changes. Therefore, even when the motion object determination method disclosed in JP 2001-021794 is applied to the AF mode switching function disclosed in JP 2004-085843, it is still difficult to shorten a time period necessary to switch the one-shot mode to the continuous mode in the macro photography. Originally, there is few necessities to detect a moving object in the macro photography.

### SUMMARY OF THE INVENTION

The present invention provides an image pickup apparatus that can quickly reduce defocus after an on-focus state is obtained in photography of a close-range object, such as macro photography, and a lens unit attachable to the image pickup apparatus.

An image pickup apparatus includes a magnification information acquisition unit configured to acquire information on an image pickup magnification of an image pickup optical system, and a controller configured to provide a focus control to the image pickup optical system. The controller is configured to select a first focus control that stops the focus control after an on-focus state of the image pickup optical system is obtained by the focus control, and a second focus control that continues the focus control even after the on-focus state of the image pickup optical system is obtained by the focus control. The controller sets the first focus control mode when the information on the image pickup magnification is information corresponding to image pickup magnification smaller than a predetermined value, and the controller sets the second focus control mode when the information on the image pickup magnification is information corresponding to image pickup magnification equal to or larger than the predetermined value.

Further features of the present invention will become apparent from the following description of exemplary embodiments with reference to the attached drawings.

### BRIEF DESCRIPTION OF THE DRAWINGS

FIG. 1 is a block diagram that illustrates a structure of a camera according to one embodiment of the present invention.

FIG. 2 is a flowchart that illustrates an operation of an automatic mode in the camera according to the present invention.

FIG. 3 is a flowchart that illustrates an AF operation in a one-shot mode in the camera according to the present invention.

FIG. 4 is a flowchart that illustrates an AF operation in a continuous mode in the camera according to the present invention.

### DESCRIPTION OF THE EMBODIMENTS

A description will now be given of one embodiment according to the present invention with reference to the accompanying drawings.

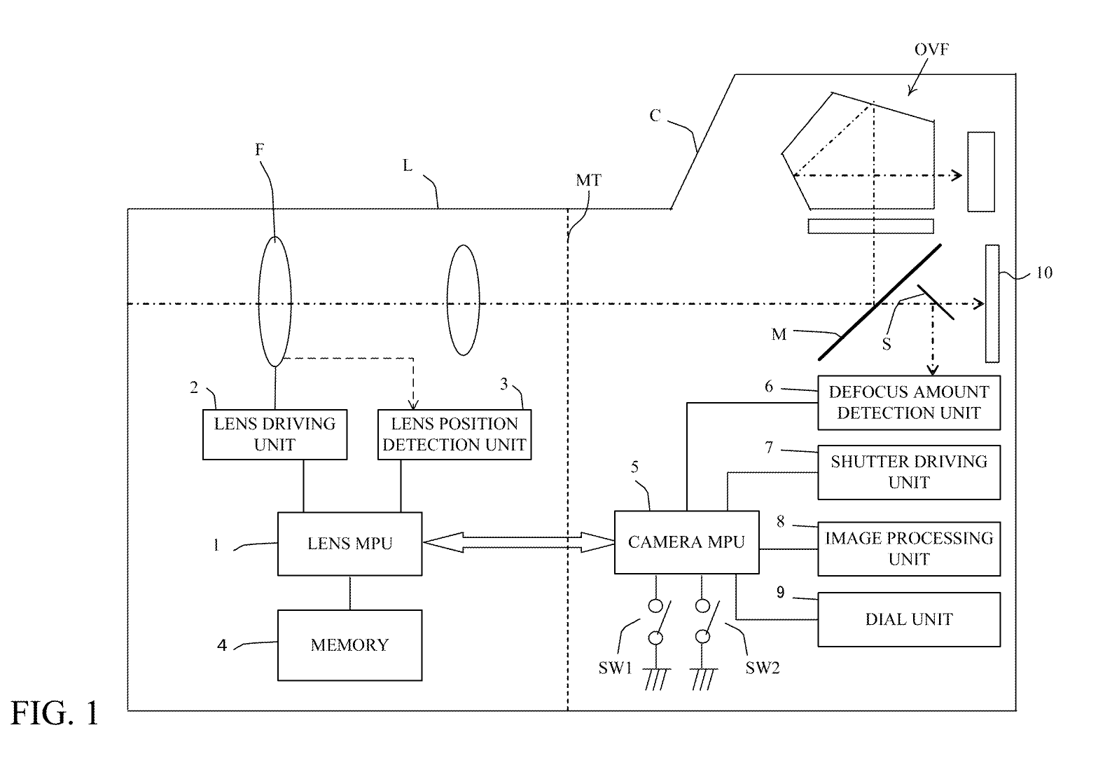

FIG. 1 illustrates a structure of a lens exchange type single-lens reflex digital camera (image pickup apparatus) according to one embodiment of the present invention. This embodiment discusses the single-lens reflex digital camera, but is be applicable to a lens integration type digital still camera or a video camera having a still image pickup function.

In FIG. 1, L denotes an exchange lens as a lens unit that includes an image pickup optical system that includes a plurality of lenses and a stop. Reference numeral 1 denotes a lens MPU configured to provide a variety of operations and a variety of controls to the exchange lens. Reference numeral 2 denotes a lens driving unit configured to move a focus lens F in the image pickup optical system in the optical axis direction. Reference numeral 3 denotes a lens position detection unit configured to detect a position of the focus lens F in the optical axis direction. Reference numeral 4 denotes a memory configured to store optical information (table data) of the image pickup optical system necessary for the focus control. The lens MPU 1 generates information on an image pickup magnification of the image pickup optical system based on a position of the focus lens F detected by the lens position detection unit 3. The information on the image pickup magnification, as used herein, may be an image pickup magnification itself or information on an object distance corresponding to the image pickup magnification or a position of the focus lens F. The following description assumes that the information on the image pickup magnification is the image pickup magnification itself.

The exchange lens L is detachably attached to the single-lens reflex digital camera (simply “camera” hereinafter) via a mount MT.

In the camera C, reference numeral 5 denotes a camera MPU as a controller configured to provide a variety of operations and a variety of controls in the camera C. The camera MPU 5 is connected communicatively to the lens MPU 1 via a connection terminal provided to the mount MT. The camera MPU 5 receives (obtains) from the lens MPU 1 a variety of information, such as a position of the focus lens F, an operational state, an image pickup magnification, and optical information of the focus lens F. The camera MPU 5 also serves as a magnification information acquisition unit configured to acquire information on an image pickup magnification from the lens MPU 1. In addition, the camera MPU 5 sends to the lens MPU 1 a command, such as a focus command and a stop command.

M denotes a main mirror configured to reflect part of light from an object through the exchange lens L and to transmit the remaining light in the viewfinder observation state (not illustrated). S denotes a sub-mirror configured to reflect light that has transmitted through the main mirror M toward a defocus amount detection unit 6 that serves as a focus detector. The light reflected on the main mirror M is led to an optical viewfinder OVF that includes a focus plate, a pentaprism, and an eyepiece lens. Thereby, the user can observe the object through the optical viewfinder OVF. The main mirror M and the sub-mirror S are configured to move up or retract from the optical path of the exchange lens L at the image pickup time.

The defocus amount detection unit 6 separates the light reflected by the sub-mirror S, forms a pair of object image, photoelectrically converts the two object images through two light receiving sensors, and generates two image signals. Then, the defocus amount detection unit 6 performs a correlation operation for these two image signals, and calculates a phase difference between the two image signals. In addition, the defocus amount detection unit 6 calculates a defocus amount corresponding to the focus state of the image pickup optical system based on the phase difference.

The camera MPU 5 calculates a movement direction and a movement amount of the focus lens F necessary to reduce the defocus amount down to zero or down to a value within a range close to zero based on the calculated defocus amount and the optical information of the image pickup optical system obtained through the lens MPU 1. Next, the camera MPU 5 sends to the lens MPU 1 a focus command that includes the movement direction and the movement amount. Thus, the camera MPU 5 provides an AF control to the image pickup optical system.

The lens MPU 1 that receives the focus command moves the focus lens F via the lens driving unit 2 according to the movement direction and the movement amount included in the focus command. Thereby, the on-focus state of the image pickup optical system corresponding to the object can be obtained.

Reference numeral 10 denotes an image pickup device that includes a photoelectric conversion element, such as a CCD sensor and a CMOS sensor. The image pickup device 10 photoelectrically converts an object image formed by the image pickup optical system, and outputs an image pickup signal. Reference numeral 7 denotes a shutter driving unit configured to control an operation of a shutter (not illustrated) configured to control an exposure amount of the image pickup device, according to the shutter control signal from a camera MPU 5.

Reference numeral 8 denotes an image processing unit configured to generate an image signal (image data) through a variety of image processing to an image pickup signal output from the image pickup device 10. The image signal is displayed on a back surface monitor (not illustrated) or recorded in a recording medium, such as a semiconductor memory.

Reference numeral 9 denotes a dial unit operated by the user for a variety of settings, such as a shutter velocity, a stop value, and an image pickup mode.

SW1 denotes an image pickup preparation switch that is turned on by a first stroke (half-press) of a release button (not illustrated). When the image pickup preparation switch SW1 turns on, the camera MPU 5 starts the AF control that includes at least from the above defocus amount detection to the focus command transmission, and a photometric operation using a photometric unit.

SW2 denotes an image pickup switch that is turned on by a second stroke operation (full press) of the release button. When the image pickup switch SW2 turns on, the camera MPU 5 moves up the main mirror M and the sub-mirror S, and opens or closes the shutter for the exposure or photography of the image pickup device 10.

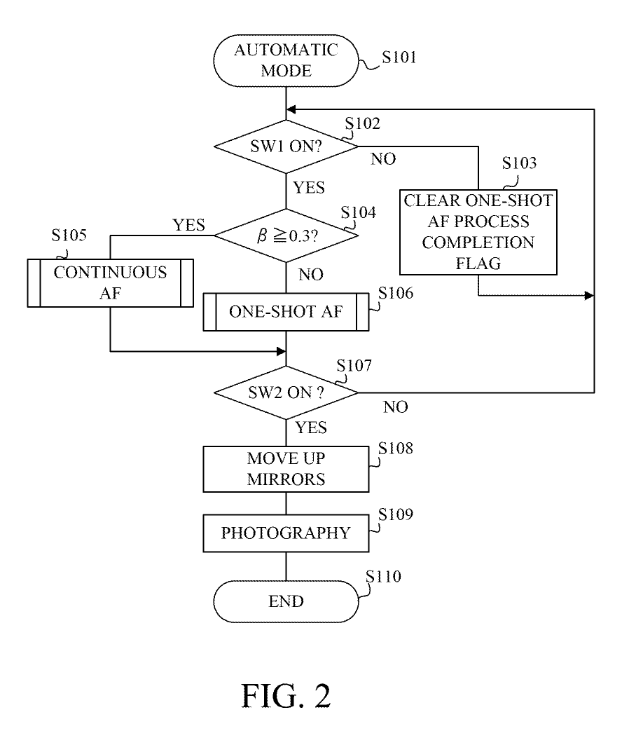

The camera MPU 5 serves to automatically switch the autofocus control mode (AF mode) between the one-shot mode (first focus control mode) and the continuous mode (second focus control mode). Referring to a flowchart of FIG. 2, a description will be given of a process to realize this function. This process is executed by the camera MPU 5 in an automatic mode of the camera (S101) in accordance with a computer program.

In a step S102, the camera MPU 5 determines whether or not the image pickup preparation switch SW1 is turned on. When the image pickup preparation switch SW1 is turned off, the flow moves to a step S103. In the step S103, the camera MPU 5 clears a flag representing a completion of the one-shot AF process (“one-shot AF process completion flag” hereinafter), and the flow returns to the step S102.

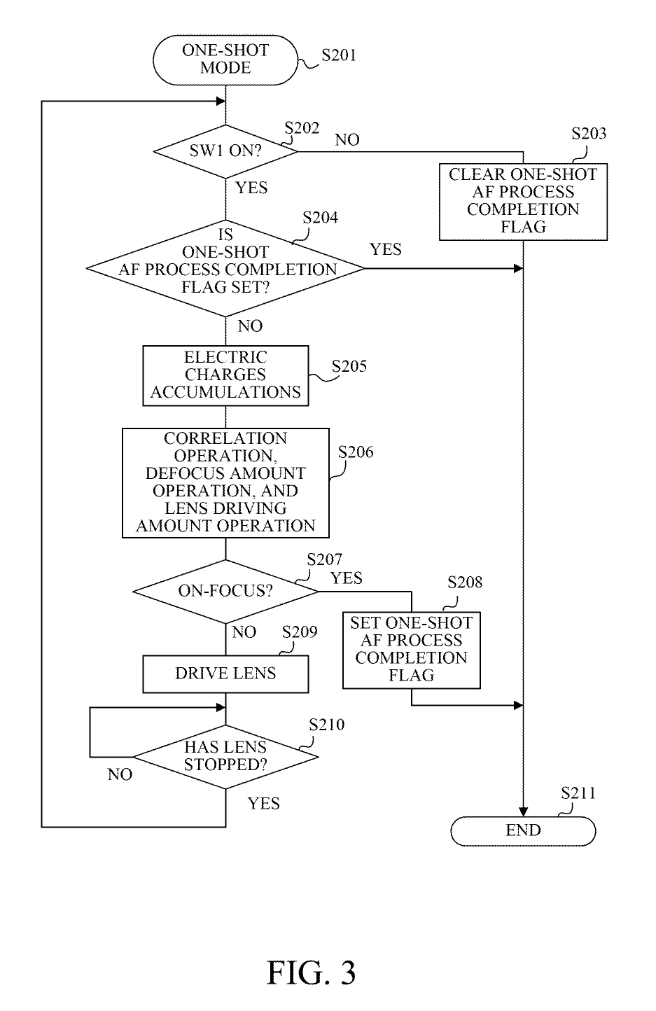

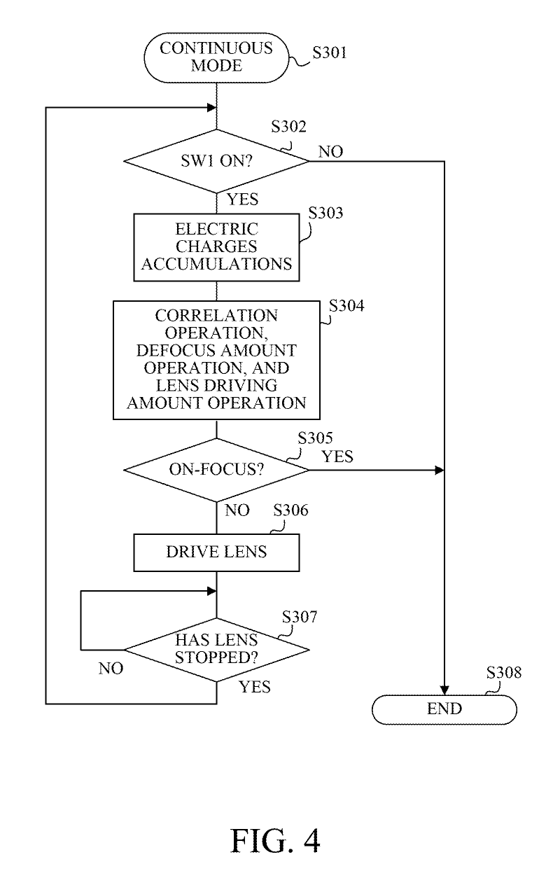

When the image pickup preparation switch SW1 is turned on in the step S102, the flow moves to a step S104. In the step S104, the camera MPU 5 determines whether or not the image pickup magnification obtained by the lens MPU 1 is equal to or larger than a predetermined magnification of 0.3 times. When the image pickup magnification R is equal to or larger than 0.3 times, the flow moves to a step S105 so as to perform the continuous mode process. On the other hand, when the image pickup magnification β is smaller than 0.3 times (for example, in the normal distance photography), the flow moves to a step S106 so as to perform the one-shot mode process. Referring now to FIGS. 3 and 4, a description will be given of the details of the one-shot mode process and the continuous mode process.

Referring now to a flowchart shown in FIG. 3, the one-shot mode process will be described. After the one-shot mode process starts in a step S201, the camera MPU 5 in a step S202 determines whether or not the image pickup preparation switch SW1 is turned on. When the image pickup preparation switch SW1 is turned off, the flow moves to the step S203 so as to clear the one-shot AF process completion flag. Next, the flow moves to the step S211 so as to end this process.

When the image pickup preparation switch SW1 is turned on in the step S202, the flow moves to a step S204. In the step S204, the camera MPU 5 determines whether or not the one-shot AF process completion flag is set. If so, the flow moves to the step S211 so as to end this process.

When the one-shot AF process completion flag has not yet been set, the flow moves to a step S205 so as to start the electric charges accumulations in the light receiving sensor of the defocus amount detection unit 6. Next, in a step S206, the camera MPU 5 performs a correlation operation (or a calculation of a phase difference) between two image signals in the defocus amount detection unit 6, calculates a defocus amount based on a phase difference, and operates a movement direction and a movement amount of the focus lens F based on the defocus amount. In addition, the camera MPU 5 obtains information on the position of the focus lens F from the lens position detection unit 3 via the lens MPU 1.

Next, the camera MPU 5 in the step S207 determines whether or not the calculated defocus amount is zero or within a predetermined range close to zero or whether or not an on-focus state is obtained. When the on-focus state is obtained, the flow moves to the step S208, and the camera MPU 5 sets the one-shot AF process completion flag.

When the on-focus state has not yet been obtained in the step S207, the flow moves to the step S209. The camera MPU 5 in the step S209 sends a focus command to the lens MPU 1 and moves the focus lens F.

Next, in a step S210, the camera MPU 5 determines whether or not the focus lens F has moved by a movement amount determined in the focus command and stopped. When it has not yet been stopped, this determination is repeated. When it has been stopped, the flow moves to the step S202.

A stop of the focus lens F in the step S210 means that the on-focus state is obtained. In the one-shot mode, after the on-focus state is obtained, the AF control is stopped until the image pickup preparation switch SW1 is again turned on (from the turn-off state). In other words, the focus lens F is not again driven.

Referring now to a flowchart of FIG. 4, a description will be given of the continuous mode process. The continuous mode process corresponds to the one-shot mode process illustrated in FIG. 3 from which the processes of the steps S203, S204, and S208 are deleted. The continuous mode starts in a step S301. A step S302 is the same as the step S202 in FIG. 3, and a step S303 is the same as the step S205 in FIG. 3. A step S304 is the same as the step S206 in FIG. 3, and steps S305, S306, and S307 are the same as the step S207, S209, and S210 in FIG. 3. The camera MPU 5 in a step S308 ends this process.

The continuous mode repeats the AF control while the image pickup preparation switch SW1 turns on, even after the on-focus state is obtained. In other words, the focus lens F is again driven whenever the defocus occurs. Thereby, when the image pickup magnification β is equal to or larger than 0.3 times (or in the photography of the close-range object such as in the macro photography), the on-focus state can be again quickly obtained when the defocus occurs due to the hand shake in the focusing direction (optical axis direction).

When the processes end in the step S211 illustrated in FIG. 3 and the step S308 illustrated in FIG. 4, the flow moves to a step S107 in FIG. 2. The camera MPU 5 in the step S107 determines whether or not the image pickup switch SW2 is turned on. When the image pickup switch SW2 is turned off, the flow returns to the step S102 and when the image pickup switch SW2 is turned on, the flow moves to the step S108.

In the step S108, the camera MPU 5 moves up the main mirror M and the sub-mirror S. Next, the camera MPU 5 in the step S109 opens or closes the shutter via the shutter driving unit 7 for image pickup. When the image pickup ends, this process ends in the step S110.

As discussed above, this embodiment sets the one-shot mode suitable for still image photography, when the image pickup magnification is smaller than the predetermined magnification (when the information on the image pickup magnification corresponds to information on the image pickup magnification smaller than the predetermined value) or in the normal distance photography. On the other hand, this embodiment automatically sets the continuous mode when the image pickup magnification is equal to or larger than the predetermined magnification (when the information on the image pickup magnification corresponds to information on the image pickup magnification equal to or larger than the predetermined value) or in the photography of the close-range object such as in the macro photography. This configuration can quickly reduce defocus in the photography of the close-range object caused by the hand shake after the on-focus state is obtained.

This embodiment is mere illustrative, and the present invention is not limited to this embodiment.

For example, the above embodiment uses 0.3 times for the predetermined magnification but may use another value (such as 0.2 and 0.5) for the predetermined magnification.

The camera may have a close-up photography mode (macro photography mode) as an image pickup mode). In this state, when the user sets the close-up photography mode through an operation of the dial unit 9, the focus control mode may be automatically switched according to the image pickup magnification as in the above embodiment.

The above embodiment discusses use of a defocus amount obtained by a phase difference detection method of the focus control. However, this embodiment may be applied to an image pickup apparatus that provides a focus control based on the TV-AF using the image pickup signal or based on the object distance obtained by a distance measurement sensor.

The above embodiment discusses the camera MPU 5 that obtains information on the image pickup magnification calculated by the lens MPU 1. However, according to this embodiment, the camera MPU 5 may calculate and obtain the information on the image pickup magnification based on the information of the position of the focus lens received by the lens MPU 1.

This embodiment automatically sets a second focus control mode (continuous mode) when an image pickup magnification is equal to or larger than a predetermined value or in photography of a close-range object, such as macro photography. Therefore, in particular, defocus caused by the hand shake after the on-focus state is obtained can be quickly reduced particularly in the photography of the close-range object.

This embodiment can provide an image pickup apparatus that can quickly reduce defocus after the on-focus is obtained in the photography of the close-range object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-216320, filed Sep. 18, 2009 which is hereby incorporated by reference herein in its entirety.

What is claimed is:

1. An image pickup apparatus comprising:
a magnification information acquisition unit configured to acquire information on an image pickup magnification of an image pickup optical system; and
a controller configured to provide a focus control to the image pickup optical system,
wherein the controller is configured to select a first focus control that stops the focus control after an on-focus state of the image pickup optical system is obtained by the focus control, and a second focus control that continues the focus control even after the on-focus state of the image pickup optical system is obtained by the focus control, and
wherein the controller sets the first focus control mode when the information on the image pickup magnification is information corresponding to image pickup magnification smaller than a predetermined value, and the controller sets the second focus control mode when the information on the image pickup magnification is information corresponding to image pickup magnification equal to or larger than the predetermined value.

2. A lens unit detachably attached to an image pickup apparatus, the lens unit comprising an image pickup optical system,
wherein the image pickup apparatus includes:
a magnification information acquisition unit configured to acquire information on an image pickup magnification of an image pickup optical system; and
a controller configured to provide a focus control to the image pickup optical system,
wherein the controller is configured to select a first focus control that stops the focus control after an on-focus state of the image pickup optical system is obtained by the focus control, and a second focus control that continues the focus control even after the on-focus state of the image pickup optical system is obtained by the focus control, and
wherein the controller sets the first focus control mode when the information on the image pickup magnification is information corresponding to image pickup magnification smaller than a predetermined value, and the controller sets the second focus control mode when the information on the image pickup magnification is information corresponding to image pickup magnification equal to or larger than the predetermined value.
